(19) United States
(12) Patent Application Publication
(10) Pub. No.: US 2020/0345029 A1
(43) Pub. Date: Nov. 5, 2020

(54) OILINESS/FATTINESS ENHANCER FOR FOODS, AND FOOD CONTAINING SAME

(71) Applicant: J-OIL MILLS, Inc., Tokyo (JP)

(72) Inventors: Misaki TSUJI, Tokyo (JP); Takahiro TOKUCHI, Tokyo (JP); Satoshi KONISHI, Tokyo (JP); Sanshiro SAITO, Tokyo (JP); Masahiro INOUE, Tokyo (JP)

(21) Appl. No.: 16/643,302

(22) PCT Filed: Sep. 28, 2018
(86) PCT No.: PCT/JP2018/036173

§ 371 Date: Feb. 28, 2020

(30) Foreign Application Priority Data
Oct. 13, 2017 (JP) 2017-199487

(51) Int. Cl. A23D 9/00; A23L 23/00; A23L 27/60; A23L 7/10

(52) U.S. Cl. CPC A23D 9/00; A23L 23/00; A23V 2002/00; A23L 7/10; A23L 27/66

(57) ABSTRACT

Provided are an oiliness/fattiness enhancer for foods in which oiliness/fattiness of a food can be enhanced, and a food in which oiliness/fattiness has been enhanced. Provided is an oiliness/fattiness enhancer for foods characterized by containing, as an active component, an oxidized oil/fat having a peroxide value of 20 or more to 400 or less and including milk fat in an amount of 10% by mass or more to 100% by mass or less. The oiliness/fattiness enhancer for foods preferably contains the oxidized oil/fat in an amount of 0.001% by mass or more to 100% by mass or less, preferably has anhydrous milk fat as the milk fat, preferably includes a pulverulent oil/fat containing the oxidized oil/fat and an excipient, and is preferably applied to a food having an oil/fat content of 0.1% by mass or more to 70% by mass or more. The food is preferably any one food selected from the group consisting of a dressing, a roux, and a soup.

### TECHNICAL FIELD

The present invention relates to an oiliness/fattiness enhancer for foods and to a food containing the same. Specifically, the present invention relates to an oiliness/fattiness enhancer for foods that can enhance oiliness/fattiness in a food having a reduced oil/fat content or a food in which oiliness/fattiness is expected, and to a food having enhanced oiliness/fattiness.

### BACKGROUND ART

Recently, to prevent metabolic syndrome and lifestyle-related diseases, and also because consumers are becoming more health-conscious, there has been a need for low-fat, low-calorie foods. There has also been a need to enhance the pleasing taste of oils/fats in meat, seafood, etc., having low amounts of oils/fats. The mechanism by which oils/fats seem to taste good is unclear, but because of their unique tastiness, foods having high oil/fat content are as popular as ever despite the need for low-fat, low-calorie foods.

In view of the above, developments have been made in regard to foods providing oiliness/fattiness while having a reduced oil/fat content to minimize fat and calories. Developments have also been made in regard to enhancing the good taste of oil/fat in foods having a low oil/fat content.

For example, Patent Document 1 discloses a low-oil/fat emulsified seasoning containing octanoic acid and/or decanoic acid, and indicates that a fullness similar to that provided by oils/fats can be increased by this low-oil/fat emulsified seasoning.

### RELATED ART DOCUMENTS

### Patent Documents

Patent Document 1: Japanese Laid-Open Patent Application No. 2016-174541

### DISCLOSURE OF THE INVENTION

### Problems to Be Solved by the Invention

However, although the low-oil/fat emulsified seasoning of Patent Document 1 has been able to impart oiliness/fattiness to foods, the strength of the seasoning has not been considered sufficient.

With the foregoing in view, it is an object of the present invention to provide an oiliness/fattiness enhancer for foods that can enhance oiliness/fattiness in foods, and a food having enhanced oiliness/fattiness.

### Means to Solve the Problems

The inventors have perfected the present invention upon discovering, as a result of thorough research intended to achieve the aforementioned purpose, that oxidized milk fat has an effect of enhancing oiliness/fattiness in foods.

Specifically, the present invention provides an oiliness/fattiness enhancer for foods characterized by containing, as an active ingredient, an oxidized oil/fat having a peroxide value of 20 or more to 400 or less and containing milk fat in an amount of 10% by mass or more to 100% by mass or less.

The oiliness/fattiness enhancer for foods of the present invention preferably contains the oxidized oil/fat in an amount of 0.001% by mass or more to 100% by mass or less.

In the oiliness/fattiness enhancer for foods of the present invention, the milk fat is preferably anhydrous milk fat.

The oiliness/fattiness enhancer for foods of the present invention preferably includes a pulverulent oil/fat containing the oxidized oil/fat and an excipient.

The oiliness/fattiness enhancer for foods of the present invention is preferably for being applied to a food having an oil/fat content of 0.1% by mass or more to 70% by mass or less.

The food in the oiliness/fattiness enhancer for foods of the present invention is preferably any one food selected from the group consisting of a dressing, a roux, and a soup.

The present invention also provides a food containing the oiliness/fattiness enhancer for foods described above.

The food of the present invention preferably contains the oxidized oil/fat in the oiliness/fattiness enhancer for foods in an amount of 0.01 ppm by mass or more to 500 ppm by mass or less.

In the food containing the oiliness/fattiness enhancer for foods of the present invention, the oil/fat content is preferably 0.1% by mass or more to 70% by mass or less.

The food containing the oiliness/fattiness enhancer for foods of the present invention is preferably any one food selected from the group consisting of a dressing, a roux, and a soup.

The food containing the oiliness/fattiness enhancer for foods of the present invention is preferably any one food selected from the group consisting of a dressing having an oil/fat content of 1% by mass or more to 40% by mass or less, a roux having an oil/fat content of 5% by mass or more to 30% by mass or less, and a soup having an oil/fat content of 0.1% by mass or more to 5% by mass or less.

### Advantageous Effects of the Invention

According to the oiliness/fattiness enhancer for foods of the present invention, the oiliness/fattiness of a food to which the enhancer is applied can be enhanced with less oil/fat blended in than in the prior art. Additionally, with a food containing the oiliness/fattiness enhancer for foods of the present invention, oiliness/fattiness can be enhanced with a smaller amount of oil/fat blended in than in the prior art. It is thereby possible to meet the needs of consumers desiring to limit calories and lipids due to being more health conscious, and also to meet the needs of enhancing the tastiness of oils/fats in foods having a low oil/fat content.

### EMBODIMENT FOR CARRYING OUT THE INVENTION

The oiliness/fattiness enhancer for foods of the present invention has oxidized oil/fat as an active ingredient. The oxidized oil/fat is obtained by oxidizing an oil/fat starting material.

In the present invention, milk fat is used as the oil/fat starting material of the oxidized oil/fat, but an edible oil/fat other than milk fat may be included. No particular limitation is provided as to the edible oil/fat other than milk fat; preferred examples include any one or more of medium-chain fatty acid triglycerides, soybean oil, rapeseed oil, corn oil, palm oil, and fractionated palm oil; more preferred examples include any one or more of medium-chain fatty acid triglycerides, soybean oil, and rapeseed oil; and even more preferred examples include any one or more of medium-chain fatty acid triglycerides and soybean oil. The oxidized oil/fat may include auxiliaries, etc., that are normally added to oils/fats as long as the effects of the present invention are not impaired.

The term “milk fat” in the present invention refers to a substance obtained by concentrating or separating an oil/fat component of raw milk taken from a dairy cow or another mammal, the oil/fat content of the substance being 80% by mass or more to 100% by mass or less. Examples include anhydrous milk fat, butter, clear butter, etc. “Anhydrous milk fat” refers to what is left when almost all components other than milkfat have been removed from cow milk, etc.; sometimes abbreviations such as AMF (butter oil) are used. Clear butter is butter with the fat component taken out. The milk fat used in the present invention is preferably anhydrous milk fat or clear butter, and is more preferably anhydrous milk fat. The oil/fat content of the milk fat is preferably 98% by mass or more to 100% by mass or less, and more preferably 99% by mass or more to 100% by mass or less.

The milk fat content included in the oxidized oil/fat of the present invention is 10% by mass or more to 100% by mass or less, preferably 20% by mass or more to 100% by mass or less, more preferably 50% by mass or more to 100% by mass or less, even more preferably 60% by mass or more to 100% by mass or less, yet even more preferably 65% by mass or more to 100% by mass or less, particularly preferably 95% by mass or more to 100% by mass or less, and most preferably 100% by mass. When the milk fat content of the oxidized oil/fat is less than 10% by mass, it tends to be the one in which the oiliness/fattiness cannot be sufficiently enhanced.

The oil/fat starting material can be oxidized to have a peroxide value (“POV”) in a prescribed range depending on the extent of oxidation. The peroxide value is 20 or more to 400 or less, preferably 30 or more to 310 or less, more preferably 40 or more to 180 or less, even more preferably 80 or more to 180 or less, and yet even more preferably 100 or more to 140 or less. When the peroxide value of the oxidized oil/fat is less than 20 or greater than 400, it tends to be the one in which the oiliness/fattiness cannot be sufficiently enhanced.

The peroxide value (POV) of the oxidized oil/fat can be measured by reacting potassium iodide with a sample and titrating iodine liberated from the potassium iodide by hydroperoxides in the oil/fat, or through other methods. More specifically, the peroxide value can be measured according to “Standard methods for the analysis of fats, oils and related materials, 2.5.2 Peroxide values”.

There is no particular limitation as to the method of oxidizing the oil/fat starting material. For example, when an oil/fat starting material is heated and oxidized, the heating temperature is preferably 65° C. or higher to 150° C. or lower, more preferably 70° C. or higher to 140° C. or lower, and even more preferably 75° C. or higher to 140° C. or lower. There is no particular limitation as to the heating time, which is preferably 1 hour or more to 100 hours or less, more preferably 3 hours or more to 80 hours or less, and even more preferably 5 hours or more to 80 hours or less.

For example, when oxygen is supplied to oxidize an oil/fat starting material, it is acceptable for oxygen alone to be the oxygen supply source, and also for oxygen in air, etc., to be included; air is preferred. The amount of oxygen supplied is preferably 0.001 to 2 L/min per kilogram of the oil/fat starting material. When air is the supply source, the amount supplied per kilogram of the oil/fat starting material is preferably 0.005 to 10 L/min, and more preferably 0.01 to 5 L/min. The oil/fat starting material is preferably stirred when so oxidized.

The oiliness/fattiness enhancer for foods of the present invention preferably contains oxidized oil/fat in an amount of 0.001% by mass or more to 100% by mass or less, more preferably 0.005% by mass or more to 50% by mass or less, and even more preferably 0.005% by mass or more to 10% by mass or less. The oiliness/fattiness of a food can be efficaciously enhanced when the prescribed oxidized oil/fat is included.

The oiliness/fattiness enhancer for foods of the present invention is preferably in the form of pulverulent oil/fat. This pulverulent oil/fat contains an excipient and an oxidized oil/fat in which the peroxide value is 20 or more to 400 or less and milk fat is contained in an amount of 10% by mass or more to 100% by mass or less.

The pulverulent oil/fat is obtained by obtaining an O/W emulsion by using a homogenizer to stir a mixture including the oxidized oil/fat, the excipient, another raw material as necessary, and water, and further drying and pulverizing the O/W emulsion. A homomixer, a high-pressure homogenizer, a thin-film revolution-type high-speed mixer, a colloid mill, an attritor mill, etc., can be used for the homogenizer. Examples of the method of drying and pulverizing include: a method combining freeze drying, vacuum drying, drum drying, or another type of drying, and freeze grinding, air flow grinding, or another type of pulverization; and a method of simultaneously performing pulverization and drying, including spray drying, spray freezing, or another type of drying. The obtained pulverulent oil/fat may be crushed, granulated, classified, or otherwise processed as necessary.

The excipient should be one that is used when oil/fat is in the form of a powder; examples include: milk protein, soybean protein, wheat protein, whole milk powder, skim milk powder, whey powder, butter milk powder, collagen, gelatin, and other proteins and decomposition products of these proteins; glucose, fructose, galactose, mannose, and other monosaccharides; lactose, sucrose, maltose, trehalose, and other disaccharides; corn syrup, dextrin, oligosaccharides, and other starch degradation products; starches; polysaccharide thickeners; and sugar alcohols. It is acceptable to use one of these excipients alone or two or more in combination.

An emulsifier can be used as the another raw material. No particular limitation is provided as long as the emulsifier is for use in foods; examples include lecithin, monoglyceride fatty acid esters, glycerin organic acid fatty acid esters, polyglycerol fatty acid esters, polyglycerin condensed ricinoleic acid esters, sorbitan fatty acid esters, sucrose fatty acid esters, propylene glycol fatty acid esters, polyoxyethylene sorbitan fatty acid esters, and calcium stearoyl lactate.

Furthermore, a pH adjuster can be used as the another raw material. No particular limitation is provided as long as the pH adjuster is for foods; examples include adipic acid, citric acid, trisodium citrate, gluconic acid, succinic acid, lactic acid, potassium carbonate, sodium hydrogen carbonate, sodium hydrogen phosphate, dipotassium hydrogen phosphate, sodium pyrophosphate, sodium metaphosphate, and sodium polyphosphate.

In the oiliness/fattiness enhancer for foods of the present invention, the oxidized oil/fat may be diluted using an edible oil/fat, in which case the amount of the oxidized oil/fat relative to the edible oil/fat is preferably 0.001% by mass or more to 50% by mass or less, more preferably 0.01% by mass or more to 50% by mass or less, even more preferably 0.01% by mass or more to 20% by mass or less, and even more preferably 0.01% by mass or more to 10% by mass or less. No particular limitation is provided as to the edible oil/fat; examples include: palm kernel oil, palm oil, coconut oil, corn oil, cottonseed oil, soybean oil, rapeseed oil, rice bran oil, sunflower seed oil, safflower oil, cacao butter, and other vegetable oils/fats; milk fat, lard, and other animal oils/fats; medium-chain fatty acid triglycerides; etc. Fractionated oils (a mid-range melting point portion from palm oil, soft-fraction oil from palm oil, hard-fraction oil from palm oil, etc.), transesterified oils, hydrogenated oils, and other processed oils/fats of these can also be used. One or more of these edible oils/fats can be used.

As described above, the oiliness/fattiness enhancer for foods preferably assumes a form that is suited for use in foods, seasonings, etc., it being possible for the oiliness/fattiness enhancer for foods to be used, inter alia, in the form of a powder such as the aforementioned pulverulent oil/fat, or a liquid such as is obtained via dilution using the aforementioned edible oil/fat.

Additives typically used in edible oils/fats can be blended into the oiliness/fattiness enhancer for foods of the present invention. Examples of additives include: tocopherol, ascorbic acid fatty acid esters, lignan, oryzanol, rosemary extract, and other antioxidants; and silicone and other antifoaming agents.

The oiliness/fattiness enhancer for foods of the present invention can enhance the oiliness/fattiness of a food by being applied to the food. The food to which the enhancer is applied has an oil/fat content of preferably 0.1% by mass or more to 70% by mass or less, more preferably 1% by mass or more to 70% by mass or less, and even more preferably 15% by mass or more to 50% by mass or less. When the enhancer is applied to a food having the prescribed oil/fat content, the oiliness/fattiness can be efficaciously enhanced.

Specific examples of such a food include dressings, roux, and soups.

“Dressing” refers to a liquid seasoning, which could be a product obtained by adding salt, sugar, or a spice/herb/liquor, etc., to an oil/fat and vinegar or citrus juice. Specific examples include French dressing, Japanese dressing, sesame dressing, Thousand Island dressing, Caesar salad dressing, creamy salad dressing, coleslaw dressing, salad dressing, sandwich spread, cheese dressing, Italian dressing, Chinese dressing, mayonnaise-like seasoning, and tartar sauce. The dressing to which the present invention is applied has an oil/fat content of preferably 1% by mass or more to 40% by mass or less.

“Roux” refers to pastes, granules, and blocks prepared by heating wheat flour or other types of flour in butter or another oil/fat. Specific examples include curry roux, Hayashi roux, white roux, demi-glace roux, pasta roux, bechamel roux, veloute roux, espagnole roux, stew roux, and potage roux. These roux can be processed into, for example, curry sauce, Hayashi sauce, white sauce, demi-glace sauce, pasta sauce, bechamel sauce, veloute sauce, espagnole sauce, and potage sauce. The roux to which the present invention is applied has an oil/fat content of preferably 5% by mass or more to 30% by mass or less.

“Soup” refers to refers to a high-water-content dish in which meat, vegetables, seafood, etc., have been stewed. Specific examples include pot dishes, soba, udon, ramen, gravies of pasta and the like, consommé soup, egg soup, wakame soup, shark fin soup, potage soup, onion soup, corn soup, Chinese soup, borscht, miso soup, and broths. Other examples are soups prepared by adding water or hot water before use, such as dry soups and soup concentrates. The soup to which the present invention is applied has an oil/fat content of preferably 0.1% by mass or more to 5% by mass or less, and more preferably 1% by mass or more to 5% by mass or less.

Examples of foods to which the oiliness/fattiness enhancer for foods of the present invention is applied, other than those given above, include meat and seafood having a low oil/fat content and foods processed therefrom; e.g., non-fried foods cooked in an oven, in steam, etc.; ham; grilled meat, grilled chicken, steak, grilled fish, grilled shrimp, and other types of grilled meat; breaded pork cutlets, breaded beef cutlets, breaded chicken cutlets, deep-fried chicken, deep-fried marinated chicken, fried chicken, salmon steak, fried horse mackerel, fried Atka mackerel, fried chub mackerel, fried cod and other white-meat fish, fried prawns, and other fried foods; butterflied Atka mackerel fillet and other dried fish; etc.

Foods of which, for example, the oil/fat content is 75% or less relative to the normal oil/fat content are preferred as the foods to which the oiliness/fattiness enhancer for foods of the present invention is applied. In this case, for example, the triacylglycerol equivalents or lipid contents of foods given in the 2015 edition (7th edition) of the Standard Tables of Food Composition of Japan can be used as the standards for the normal oil/fat content of the foods.

Further examples of the form of the oiliness/fattiness enhancer for foods include liquid batters, breaders, pickling liquids, and tumbling liquid.

The food containing the oiliness/fattiness enhancer for foods of the present invention contains the oxidized oil/fat in the oiliness/fattiness enhancer for foods in an amount of preferably 0.01 ppm by mass or more to 500 ppm by mass or less, more preferably 0.1 ppm by mass or more to 350 ppm by mass or less, and even more preferably 1 ppm by mass or more to 200 ppm by mass or less. Oiliness/fattiness is efficaciously enhanced in foods containing the oiliness/fattiness enhancer for foods in the prescribed range.

### EXAMPLES

Examples are given below to describe the present invention in further detail, but these examples are not provided by way of limitation on the present invention.

<1. Preparation of Reference Mayonnaise>

A mayonnaise-like seasoning/mayonnaise (referred to below as “reference mayonnaise”) to be used as a reference for evaluating oiliness/fattiness was manufactured.

1. Preparation of Mayonnaise-Like Seasoning having Oil Content of 10% by Mass

Following the quantities under the heading “oil content 10% by mass” in table 1 below, starch and water were introduced into a stainless-steel flat-bottomed pot and heated while being mixed over an Induction heater (model no.: KZ-PH1, Matsushita Electric Industrial), and the water was evaporated until the mass decreased with 30 g, resulting in a paste. After all materials other than the oil/fat were added and mixed into the manufactured paste, the oil/fat was added successively in small quantities, the mixture was sufficiently stirred with a hand mixer until uniform, and a mayonnaise-like seasoning having an oil content of 10% by mass was prepared.

TABLe 1

| | | Oil | Oil |
|---|---|---|---|
| | | content: | content: |
| Raw material | | 10% by mass | 80% by mass |
| Oil/fat | Rapeseed oil (J-Oil Mills) | 30 | 240 |

| | | |
|---|---|---|
| Water | 225 | |
| Starch | 15 | |
| Whole eggs | 36 | 36 |
| Salt | 3 | 3 |
| Grain vinegar (Kabshiki kaisha Mizkan) | 21 | 21 |
| Total mass of blended amount | 330 | 300 |
| Mass of finished product | 300 | 300 |

units: g

2. Preparation of Mayonnaise having Oil Content of 80% by Mass

Using the amounts under the heading “oil content 80% by mass” in table 1 above, all materials other than oil/fat were mixed in and a water phase was manufactured. Oil/fat was added successively in small quantities to the manufactured water phase, the mixture was sufficiently stirred with a hand mixer until uniform, and a mayonnaise having an oil content of 80% by mass was prepared.

3. Preparation of Reference Mayonnaise

The mayonnaise-like seasoning having an oil content of 10% by mass and the mayonnaise having an oil content of 80% by mass prepared as described above were mixed, and reference mayonnaises having an oil content of 10, 12.5, 15, 20, 30, 40, 50, 60, 70, and 80% by mass were prepared.

<2. Examination of Oil/Fat Starting Material>

The differences in effects due to an oil/fat starting material of oxidized oil/fat were examined. Rapeseed oil, anhydrous milk fat, or butter was used as the oil/fat starting material, and the prepared oxidized oils/fats are shown in table 2.

1. Preparation of Oxidized Oil/Fat

(1) Preparation of Oxidized Oil/Fat (Oxidized Rapeseed Oil) using Rapeseed Oil as an Oil/Fat Starting Material (Preparation Example 1)

200 g of rapeseed oil (product name: Sarasara Canola Oil, J-Oil Mills) were introduced into a stainless-steel beaker and stirred while being heated at 100° C., and air (200 mL/min) was supplied. The air supply time was 10.5 hours, and after the mixture cooled, oxidized rapeseed oil was obtained. The peroxide value (POV) of the obtained oxidized rapeseed oil was found to be 47 upon being measured according to “Standard methods for the analysis of fats, oils and related materials, 2.5.2 Peroxide values”.

(2) Preparation of Oxidized Oil/Fat (Oxidized Milk Fat) using Anhydrous Milk Fat as an Oil/Fat Starting Material (Preparation Example 2)

200 g of anhydrous milk fat (product name: Butter Oil CML, Maruwayushi; oil/fat content: 99.8% by mass) was introduced into a stainless-steel beaker and stirred while being heated to 100° C., and air (200 mL/min) was supplied. The air supply time was 5.2 hours, and after the mixture cooled, oxidized milk fat was obtained, and the peroxide value was measured to be 46.

(3) Preparation of Oxidized Oil/Fat (Oxidized Butter) using Butter as an Oil/Fat Starting Material (Preparation Example 3)

200 g of butter (product name: Snow Brand Hokkaido Butter, Megmilk Snow Brand; oil/fat content: 81% by mass) were introduced into a stainless-steel beaker and stirred while being heated to 100° C., and air (200 mL/min) was supplied. The air supply time was 72.5 hours, after the mixture cooled, oxidized butter was obtained, and the peroxide value was measured to be 56.

TABLE 2

| | Prepar. | Prepar. | Prepar. | Prepar. | Prepar. | Prepar. | Prepar. | Prepar. |
|---|---|---|---|---|---|---|---|---|
| | Example | Example | Example | Example | Example | Example | Example | Example |
| | 1 | 2 | 3 | 4 | 5 | 6 | 7 | 8 |
| Oil/fat | Rapeseed | Anhydrous | Butter | Anhydrous | Anhydrous | Anhydrous | Anhydrous | Anhydrous |
| starting | oil | milk | | milk | milk | milk | milk | milk |
| material | | fat | | fat | fat | fat | fat | fat |
| Peroxide | 47 | 46 | 56 | 34 | 83 | 120 | 180 | 310 |
| value (POV) | | | | | | | | |
| Supply time | 10.5 | 5.2 | 72.5 | 5 | 5.2 | 6.5 | 7.6 | 9.9 |
| (time) | | | | | | | | |

2. Preparation of Low-Oil-Content Mayonnaise-like Seasoning

Using the same method as “Preparation of mayonnaise-like seasoning having oil content of 10% by mass” above, the quantities of table 3 were followed instead of those in table 1, and low-oil-content mayonnaise-like seasonings having oxidized oils/fats blended in were prepared. To add the oils/fats, a procedure was carried out in which rapeseed oil blended with oxidized oil/fat was first added and rapeseed oil was then added in successive, small amounts.

TABLE 3

| | | Comparative | | |
|---|---|---|---|---|
| | | Example 1 | Exam- | Exam- |
| | | Oxidized | ple 1 | ple 2 |
| | | rapeseed | Oxidized | Oxidized |
| Raw Material | | oil | milk fat | butter |
| Oil/fat | Rapeseed oil | 18 | 18 | 18 |
| | (J-Oil Mills) | | | |
| | Rapeseed oil blended | | 2 | |
| | with 1 mass % | | | |
| | oxidized milk | | | |
| | fat (POV 46) | | | |
| | Rapeseed oil blended | 2 | | |
| | with 1 mass % | | | |
| | oxidized rapeseed | | | |
| | oil (POV 47) | | | |
| | Rapeseed oil blended | | | 2 |
| | with 1 mass % | | | |
| | oxidized butter | | | |
| | (POV 56) | | | |

| | | | |
|---|---|---|---|
| Water | 160 | 160 | 160 |
| Starch | 10 | 10 | 10 |
| Whole eggs | 24 | 24 | 24 |
| Salt | 2 | 2 | 2 |
| Grain vinegar (Kabshiki | 14 | 14 | 14 |
| kaisha Mizkan) | | | |
| Total mass of | 230 | 230 | 230 |
| blended amount | | | |
| Mass of finished product | 200 | 200 | 200 |

units: g

3. Evaluation A with Reference Mayonnaise

For the low-oil-content mayonnaise-like seasonings blended with oxidized oil/fat using rapeseed oil, anhydrous milk fat, or butter as the oil/fat starting material, an evaluation was made of how the oil content of the reference mayonnaise prepared as described above corresponded to oiliness/fattiness. The results are shown in Table 4. When, for example, a mayonnaise-like seasoning containing an oxidized oil/fat in an amount of 100 ppm by mass and having an oil content of 10% by mass had an oiliness/fattiness similar to that of the reference mayonnaise having an oil content of 40% by mass, the enhancement rate was calculated as (40% by mass−(10% by mass−100 ppm by mass))/100 ppm by mass=3001. The evaluation was made by three panelists and the enhancement rate was determined by consensus.

With the low-oil-content mayonnaise-like seasoning blended with oxidized oil/fat using anhydrous milk fat as the oil/fat starting material (Example 1), an oiliness/fattiness corresponding to the reference mayonnaise having an oil content of 60% by mass was obtained, the enhancement rate was a high value; i.e., 5001, and the results indicated that oiliness/fattiness was sufficiently enhanced. With the low-oil-content mayonnaise-like seasoning blended with oxidized oil/fat using butter as the oil/fat starting material (Example 2), an oiliness/fattiness corresponding to the reference mayonnaise having an oil content of 30% by mass was obtained, the enhancement rate was a high value; i.e., 2001, and the results indicated that oiliness/fattiness was sufficiently enhanced.

With the low-oil-content mayonnaise-like seasoning blended with oxidized oil/fat using rapeseed oil as the oil/fat starting material (Comparative Example 1), any oiliness/fattiness corresponding to the reference mayonnaise having an oil content of over 15% by mass was not achieved, the enhancement rate was 501, and the result indicated that oiliness/fattiness was not sufficiently enhanced.

TABLE 4

| | Comparative | | |
|---|---|---|---|
| | Example 1 | Example 1 | Example 2 |
| Oil/fat starting material | Rapeseed | Anhydrous | Butter |
| | oil | milk fat | |
| Peroxide value (POV) | 47 | 46 | 56 |
| Added concentration of | 100 | 100 | 100 |
| oxidized oil/fat | | | |
| (ppm by mass) | | | |
| Oil content of corresponding | 15% by mass | 60% by mass | 30% by mass |
| reference mayonnaise | | | |
| Enhancement rate | 501 | 5001 | 2001 |
| Comments | No burnt | No burnt | Some burnt |
| | odor | odor | odor |

<3. Examination of Peroxide Value>

The difference in effect due to the peroxide value of the oxidized oil/fat was examined. Oxidized oils/fats in which the oil/fat starting material was anhydrous milk fat and the peroxide values were 46, 34, 83, 120, 180, and 310 (Preparation Examples 2 and 4 to 8) were used.

1. Preparation of Oxidized Oil/Fat (Preparation Examples 4 to 8)

Except for the air supply time in the above section “(2) Preparation of oxidized oil/fat using anhydrous milk fat as an oil/fat starting material” being changed to the values in table 2, the same method was used to prepare oxidized oils/fats having these peroxide values (Preparation Examples 4 to 8). The prepared oxidized oils/fats are shown in table 2.

2. Preparation 1 of Low-Oil-Content Mayonnaise-Like Seasoning

Using the same method as in the above section “Preparation of mayonnaise-like seasoning having oil content of 10% by mass” and following the quantities of table 5 instead of table 1, low-oil-content mayonnaise-like seasonings having the oxidized oils/fats blended in were prepared. To add the oils/fats, a procedure was carried out in which rapeseed oil blended with anhydrous milk fat or rapeseed oil blended with oxidized oil/fat was first added and rapeseed oil was then added in successive, small amounts.

TABLE 5

| | | Compar- | Ex- | Ex- | Ex- | Ex- |
|---|---|---|---|---|---|---|
| | | ative | am- | am- | am- | am- |
| | | Exam- | ple | ple | ple | ple |
| | | ple 2 | 3 | 1 | 4 | 5 |
| Raw | | POV | POV | POV | POV | POV |
| material | | 0 | 34 | 46 | 83 | 120 |
| Oil/fat | Rapeseed oil (J-Oil | 18 | 18 | 18 | 18 | 18 |
| | Mills) | | | | | |
| | Rapeseed oil blended | 2 | | | | |
| | with 1 mass % | | | | | |
| | Anhydrous milk fat | | | | | |
| | (POV 0) | | | | | |
| | Rapeseed oil blended | | 2 | | | |
| | with 1 mass % | | | | | |
| | oxidized milk fat | | | | | |
| | (POV 34) | | | | | |
| | Rapeseed oil blended | | | 2 | | |
| | with 1 mass % | | | | | |
| | oxidized milk fat | | | | | |
| | (POV 46) | | | | | |
| | Rapeseed oil blended | | | | 2 | |
| | with 1 mass % | | | | | |
| | oxidized milk fat | | | | | |
| | (POV 83) | | | | | |
| | Rapeseed oil blended | | | | | 2 |
| | with 1 mass % | | | | | |
| | oxidized milk fat | | | | | |
| | (POV 120) | | | | | |

| | | | | | |
|---|---|---|---|---|---|
| Water | 160 | 160 | 160 | 160 | 160 |
| Starch | 10 | 10 | 10 | 10 | 10 |
| Whole eggs | 24 | 24 | 24 | 24 | 24 |
| Salt | 2 | 2 | 2 | 2 | 2 |
| Grain vinegar (Kabshiki | 14 | 14 | 14 | 14 | 14 |
| kaisha Mizkan) | | | | | |
| Total mass of blended amount | 230 | 230 | 230 | 230 | 230 |
| Mass of finished product | 200 | 200 | 200 | 200 | 200 |

units: g

3. Evaluation 1 with Reference Mayonnaise

The low-oil-content mayonnaise-like seasonings blended with oxidized oils/fats having different peroxide values were evaluated in the same manner as in the above section “Evaluation A with reference mayonnaise.” The results are shown in table 6.

With the low-oil-content mayonnaise-like seasonings blended with oxidized oils/fats having peroxide values of 34 to 120 (Examples 1 and 3 to 5), oiliness/fattiness corresponding to that of reference mayonnaise having an oil content of 30 to 80% by mass was obtained, the enhancement rates were high values; i.e., 2001 to 7001, and the results indicated that oiliness/fattiness was sufficiently enhanced.

With the low-oil-content mayonnaise-like seasonings blended with oxidized oils/fats (Comparative Example 2), any oiliness/fattiness corresponding to that of reference mayonnaise having an oil content of over 10% by mass was not achieved, the enhancement rate was 1, and the results indicated that oiliness/fattiness was not sufficiently enhanced.

TABLE 6

| | Compara- | | | | |
|---|---|---|---|---|---|
| | tive | | | | |
| | Example | Example | Example | Example | Example |
| | 2 | 3 | 1 | 4 | 5 |
| Peroxide value | 0 | 34 | 46 | 83 | 120 |
| Added concen- | 100 | 100 | 100 | 100 | 100 |
| tration of | | | | | |
| oxidized oil/fat | | | | | |
| (ppm by mass) | | | | | |
| Oil content of | 10 mass | 30 mass | 60 mass | 70 mass | 80 mass |
| corresponding | % | % | % | % | % |
| reference | | | | | |
| mayonnaise | | | | | |
| Enhancement | 1 | 2001 | 5001 | 6001 | 7001 |
| rate | | | | | |

4. Preparation 2 of Low-Oil-Content Mayonnaise-Like Seasoning

Using the same method as in the above section “Preparation of mayonnaise-like seasoning having oil content of 10% by mass” and following the quantities of table 7 instead of table 1, low-oil-content mayonnaise-like seasonings having the oxidized oils/fats blended in were prepared. To add the oils/fats, a procedure was carried out in which rapeseed oil blended with oxidized oil/fat was first added and rapeseed oil was then added in successive, small amounts.

TABLE 7

| | | Exam- | Exam- | Exam- |
|---|---|---|---|---|
| | | ple 6 | ple 7 | ple 8 |
| | | POV | POV | POV |
| Raw material | | 120 | 180 | 310 |
| Oil/fat | Rapeseed oil (J-Oil Mills) | 18 | 18 | 18 |
| | Rapeseed oil blended with 0.05 mass | 2 | | |
| | % oxidized milk fat (POV 120) | | | |
| | Rapeseed oil blended with 0.05 mass | | 2 | |
| | % oxidized milk fat (POV 180) | | | |
| | Rapeseed oil blended with 0.05 mass | | | 2 |
| | % oxidized milk fat (POV 310) | | | |

| | | | |
|---|---|---|---|
| Water | 160 | 160 | 160 |
| Starch | 10 | 10 | 10 |
| Whole eggs | 24 | 24 | 24 |
| Salt | 2 | 2 | 2 |
| Grain vinegar (Kabshiki kaisha Mizkan) | 14 | 14 | 14 |
| Total mass of blended amount | 230 | 230 | 230 |
| Mass of finished product | 200 | 200 | 200 |

units: g

5. Evaluation 2 with Reference Mayonnaise

The low-oil-content mayonnaise-like seasonings blended with oxidized oils/fats having different peroxide values were evaluated in the same manner as in the above section “Evaluation A with reference mayonnaise.” The results are shown in table 8.

With the low-oil-content mayonnaise-like seasonings blended with oxidized oils/fats having peroxide values of 120 to 310 (Examples 6 to 8), oiliness/fattiness corresponding to that of reference mayonnaise having an oil content of 20 to 50% by mass was obtained, the enhancement rates were high values; i.e., 20001 to 80001, and the results indicated that oiliness/fattiness was sufficiently enhanced.

TABLE 8

| | Example | Example | Example |
|---|---|---|---|
| | 6 | 7 | 8 |
| Peroxide value | 120 | 180 | 310 |
| Added concentration of | 5 | 5 | 5 |
| oxidized oil/fat (ppm | | | |
| by mass) | | | |
| Oil content of | 50 mass % | 30 mass % | 20 mass % |
| corresponding reference | | | |
| mayonnaise | | | |
| Enhancement rate | 80001 | 40001 | 20001 |

<4. Examination of Added Amount of Oxidized Oil/Fat>

The difference in effect due to the added amount of oxidized oil/fat was examined. The examination was performed using an oxidized oil/fat (Preparation Example 2) of which the oil/fat starting material was anhydrous milk fat and the peroxide value was 46.

1. Preparation of Low-Oil-Content Mayonnaise-Like Seasoning

Using the same method as in the above section “Preparation of mayonnaise-like seasoning having oil content of 10% by mass” and following the quantities of table 9 instead of table 1, low-oil-content mayonnaise-like seasonings having the oxidized oils/fats blended in were prepared. To add the oils/fats, a procedure was carried out in which rapeseed oil blended with oxidized oil/fat was first added and rapeseed oil was then added in successive, small amounts.

TABLE 9

| | | Example 9 | Example 1 |
|---|---|---|---|
| | | Oxidized | Oxidized |
| | | milk fat: | milk fat: |
| Raw Material | | 5 ppm | 100 ppm |
| Oil/fat | Rapeseed oil (J-Oil Mills) | 18 | 18 |
| | Rapeseed oil blended with 0.05 mass | 2 | |
| | % oxidized milk fat (POV 46) | | |
| | Rapeseed oil blended with 1 mass % | | 2 |
| | oxidized milk fat (POV 46) | | |

| | | |
|---|---|---|
| Water | 160 | 160 |
| Starch | 10 | 10 |
| Whole eggs | 24 | 24 |
| Salt | 2 | 2 |
| Grain vinegar (Kabshiki kaisha Mizkan) | 14 | 14 |
| Total mass of blended amount | 230 | 230 |
| Mass of finished product | 200 | 200 |

units: g

2. Evaluation with Reference Mayonnaise

The low-oil-content mayonnaise-like seasonings blended with oxidized oils/fats in different amounts were evaluated in the same manner as in the above section “Evaluation A with reference mayonnaise.” The results are shown in table 10.

With the low-oil-content mayonnaise-like seasonings blended with oxidized oils/fats in which the added amounts of oxidized oil/fat were respectively 5 and 100 ppm by mass (Examples 9 and 1), an oiliness/fattiness corresponding to that of reference mayonnaise having an oil content of 30 and 60% by mass was obtained, the enhancement rates were high values; i.e., 40001 and 5001, and the results indicated that oiliness/fattiness was sufficiently enhanced.

TABLE 10

| | Example 9 | Example 1 |
|---|---|---|
| Added concentration of | 5 | 100 |
| oxidized oil/fat (ppm by | | |
| mass) | | |
| Peroxide value | 46 | 46 |
| Oil content of | 30 mass % | 60 mass % |
| corresponding reference | | |
| mayonnaise | | |
| Enhancement rate | 40001 | 5001 |

<5. Examination of Pulverulent Oil/Fat>

The effects of pulverulent oil/fat containing an oxidized oil/fat (also referred to below as “pulverized oxidized oil/fat”) were examined.

1. Preparation of Pulverulent Oil/Fat

86.03 parts by mass of water was added to 113.97 parts by mass of a composition obtained by mixing raw materials in the ratios shown in table 11, and a mixture having a water content of 50% by mass was obtained. The obtained mixture was emulsified using a high-pressure homogenizer (LAB 2000; APV) in which a primary pressure was 500 bar and a secondary pressure was 50 bar, whereby an O/W type emulsion was obtained. The obtained emulsion was further dried and pulverized using a spray dryer (B-290; Nihon BUCHI), whereby a pulverized oxidized oil/fat (oil/fat content 50% by mass) was obtained.

TABLE 11

| Raw material | | Parts by mass |
|---|---|---|
| Extremely hardened palm kernel oil (J-Oil Mills) | | 49.99 |
| Oxidized milk fat (POV 46) | | 0.01 |
| Excipient | Corn syrup (water 25% by mass) | 55.87 |
| pH adjuster | Mixture of dipotassium hydrogen | 2.1 |
| mix | phosphate and trisodium citrate | |
| Emulsifier | Mixture of acid casein, sodium | 6.0 |
| mix | hydroxide, sorbitan fatty acid ester, | |
| | and glycerin fatty acid ester | |
| Total | | 113.97 |

2. Preparation of Low-Oil-Content Mayonnaise-Like Seasoning using Oxidized Oil/Fat (Preparation of Example 10)

Using the same method as in the above section “Preparation of mayonnaise-like seasoning having oil content of 10% by mass” and following the quantities in table 12 instead of those in table 1, a low-oil-content mayonnaise-like seasoning having oxidized oil/fat blended in was prepared. To add the oil/fat, a procedure was carried out in which rapeseed oil blended with oxidized oil/fat was first added and rapeseed oil was then added in successive, small amounts.

TABLE 12

| | | | Example 11 |
|---|---|---|---|
| | | Example 10 | Pulverized |
| | | Oxidized | oxidized |
| Raw Material | | milk | oil/fat |
| Oil/fat | Rapeseed oil (J-Oil Mills) | 19 | 15 |
| | Rapeseed oil blended with 0.1 mass | 1 | |
| | % oxidized milk fat (POV 46) | | |
| | Pulverulent oil/fat containing 0.01 | | 10 |
| | mass % oxidized milk fat (POV 46) | | |

| | | |
|---|---|---|
| Water | 160 | 155 |
| Starch | 10 | 10 |
| Whole eggs | 24 | 24 |
| Salt | 2 | 2 |
| Grain vinegar (Kabshiki kaisha Mizkan) | 14 | 14 |
| Total mass of blended amount | 230 | 230 |
| Mass of finished product | 200 | 200 |

units: g

3. Preparation of Low-Oil-Content Mayonnaise-Like Seasoning using Pulverized Oxidized Oil/Fat (Preparation of Example 11)

Using the same method as in the above section “Preparation of mayonnaise-like seasoning having oil content of 10% by mass” and following the quantities in table 12 instead of those in table 1, a low-oil-content mayonnaise-like seasoning having pulverized oxidized oil/fat blended in was prepared. The pulverized oxidized oil/fat was introduced into a pot together with water and starch, and a paste was manufactured.

4. Evaluation with Reference Mayonnaise

Low-oil-content mayonnaise-like seasonings blended with oiliness/fattiness enhancers for foods in different forms were evaluated using the same method as in “Evaluation A with reference mayonnaise” above. The results are shown in table 13.

With the low-oil-content mayonnaise-like seasoning blended with oxidized oil/fat that had not been pulverized (Example 10), oiliness/fattiness corresponding to that of reference mayonnaise having an oil content of 30% by mass was obtained, the enhancement rate was a high value; i.e., 40001, and the results indicated that oiliness/fattiness was sufficiently enhanced. With the low-oil-content mayonnaise-like seasoning blended with oxidized oil/fat that had been pulverized (Example 11), oiliness/fattiness corresponding to that of reference mayonnaise having an oil content of 60% by mass was obtained, the enhancement rate was a high value; i.e., 100001, and the results indicated that oiliness/fattiness was further enhanced.

TABLE 13

| | Example 10 | Example 11 |
|---|---|---|
| | Oxidized milk | Pulverized |
| | fat | oxidized oil/fat |
| Added concentration | 5 | 5 |
| of oxidized oil/fat | | |
| (ppm by mass) | | |
| Peroxide value | 46 | 46 |
| Oil content of | 30 mass % | 60 mass % |
| corresponding | | |
| mayonnaise | | |
| Enhancement rate | 40001 | 100001 |

<6. Examination with Soup>

The difference in effects due to the oil/fat starting material of oxidized oil/fat was examined in soup. The oxidized oils/fats used were oxidized oil/fat prepared using rapeseed oil as the oil/fat starting material (Preparation Example 1), and oxidized oil/fat prepared using anhydrous milk fat as the oil/fat starting material (Preparation Example 2).

1. Preparation of Pulverulent Oil/Fat (Preparation Examples 9 to 12)

To a composition obtained by mixing raw materials in the ratios shown in table 14 and having a solids content of 100 parts by mass, water was added so that the total was 200 parts by mass and a mixture having a water content of 50% by mass was obtained. The obtained mixture was emulsified using a high-pressure homogenizer (LAB 2000; APV) in which a primary pressure was 500 bar and a secondary pressure was 50 bar, whereby an 0/W type emulsion was obtained. The obtained emulsion was further dried and pulverized using a spray dryer (B-290; Nihon BUCHI), whereby a pulverulent oil/fat (Preparation Example 9: oil/fat content: 30% by mass; Preparation Examples 10-12: oil/fat content: 21% by mass) was obtained.

TABLE 14

| | | Prepar. | Prepar. | Prepar. | Prepar. |
|---|---|---|---|---|---|
| | | Exam- | Exam- | Exam- | Exam- |
| Raw material | | ple 9 | ple 10 | ple 11 | ple 12 |
| Extremely hardened palm kernel | | 30.0 | 21.0 | 11.0 | 11.0 |
| oil (J-Oil Mills) | | | | | |
| Oxidized milk fat (POV 46) | | | | 10.0 | |
| Oxidized rapeseed oil (POV 47) | | | | | 10.0 |
| Excipient | Corn syrup (water 25% | 82.7 | 94.7 | 94.7 | 94.7 |
| | by mass) | | | | |
| pH | Mixture of dipotassium | 2.6 | 2.6 | 2.6 | 2.6 |
| adjuster | hydrogen phosphate | | | | |
| mix | and trisodium citrate | | | | |
| Emulsifier | Mixture of acid casein, | 5.4 | 5.4 | 5.4 | 5.4 |
| mix | sodium hydroxide, | | | | |
| | sorbitan fatty acid | | | | |
| | ester, and glycerin | | | | |
| | fatty acid ester | | | | |
| Total | | 120.7 | 123.7 | 123.7 | 123.7 |

units: parts by mass

2. Preparation of Soup (Reference Examples 1 and 2, Example 12, Comparative Example 3)

Following the quantities in table 15 below, water was introduced into a stainless-steel flat-bottomed pot and heated using an induction heater (KZ-PH1; Matsushita Electric Industrial), and the water was boiled. A seasoning mix was added to and stirred in the boiling water, and when 6% by mass of the water had evaporated, heating was stopped, pulverulent oil/fat was added, and the mixture was further stirred sufficiently, whereby a soup was prepared.

TABLE 15

| | Ref. | Ref. | | Compara- |
|---|---|---|---|---|
| | Example 1 | Example 2 | Exam- | tive Exam- |
| Material | (Control) | (Control) | ple 12 | ple 3 |
| Seasoning mix | 1.5 | 1.5 | 1.5 | 1.5 |
| Water | 97.5 | 97.5 | 97.5 | 97.5 |
| Pulverulent oil/fat | 7.0 | | | |
| (Prepar. Example 9) | | | | |
| Pulverulent oil/fat | | 7.0 | 6.8 | 6.8 |
| (Prepar. Example 10) | | | | |
| Pulverulent oil/fat | | | 0.2 | |
| (Prepar. Example 11) | | | | |
| Pulverulent oil/fat | | | | 0.2 |
| (Prepar. Example 12) | | | | |
| Blending total | 106.0 | 106.0 | 106.0 | 106.0 |
| Finished product total | 100.0 | 100.0 | 100.0 | 100.0 |
| Oil content in finished | 2.1 | 1.5 | 1.5 | 1.5 |
| product | | | | |
| Oxidized oil/fat | — | — | 200 ppm | 200 ppm |
| content in finished | | | by mass | by mass |
| product | | | | |

units: % by mass except where otherwise noted
(Note)
Seasoning mix: a mixture of salt, powder sugar, ajinomoto (Ajinomoto Co., Inc.), chicken extract, white pepper, carrot powder, onion powder, and garlic powder

3. Evaluation of Oiliness/Fattiness

For soup blended with pulverulent oil/fat containing an oxidized oil/fat of which the oil/fat starting material was rapeseed oil or anhydrous milk fat, oiliness/fattiness was evaluated by making comparisons with Reference Examples 1 and 2 prepared as described above. The results are shown in table 16. The evaluation was made by three panelists through consensus.

With a soup that had an oil content of 1.5% by mass and was blended with pulverulent oil/fat containing an oxidized oil/fat of which the oil/fat starting material was anhydrous milk fat (Example 12), the same oiliness/fattiness as soup having an oil content of 2.1% by mass (Reference Example 1) was obtained, and the results indicated that oiliness/fattiness was enhanced. With a soup that had an oil content of 1.5% by mass and was blended with pulverulent oil/fat containing an oxidized oil/fat of which the oil/fat starting material was rapeseed oil (Comparative Example 3), the same oiliness/fattiness as soup having an oil content of 1.5% by mass (Reference Example 2) was obtained, and the results indicated that there was no effect of enhancing oiliness/fattiness.

TABLE 16

| Example 12 | Comparative Example 3 |
|---|---|
| Oiliness/fattiness similar | Oiliness/fattiness similar |
| to Ref. Example 1 | to Ref. Example 2 |

<7. Examination with Roux (Curry Roux)>

The difference in effects depending on the oil/fat starting material of the oxidized oil/fat was examined with roux (curry roux). The oxidized oil/fat used was oxidized oil/fat prepared using rapeseed oil as the oil/fat starting material (Preparation Example 1), and oxidized oil/fat prepared using anhydrous milk fat as the oil/fat starting material (Preparation Example 2).

1. Preparation of Pulverulent Oil/Fat (Preparation Examples 13 to 15)

To a composition obtained by mixing raw materials in the ratios shown in table 17 and having a solids content of 100 parts by mass, water was added so that the total was 200 parts by mass and a mixture having a water content of 50% by mass was obtained. The obtained mixture was emulsified using a high-pressure homogenizer (LAB 2000; APV) in which a primary pressure was 500 bar and a secondary pressure was 50 bar, whereby an O/W type emulsion was obtained. The obtained emulsion was further dried and pulverized using a spray dryer (B-290; Nihon BUCHI), whereby a pulverulent oil/fat (oil/fat content 45% by mass) was obtained.

TABLE 17

| | | Prepar. | Prepar. | Prepar. |
|---|---|---|---|---|
| | | Example | Example | Example |
| Raw material | | 13 | 14 | 15 |
| Extremely hardened palm kernel oil | | 45.0 | 44.0 | 44.0 |
| (J-Oil Mills) | | | | |
| Oxidized milk fat (POV 46) | | | 1.0 | |
| Oxidized rapeseed oil (POV 47) | | | | 1.0 |
| Excipient | Corn syrup (water 25% | 63.3 | 63.3 | 63.3 |
| | by mass) | | | |
| pH | Mixture of dipotassium | 2.1 | 2.1 | 2.1 |
| adjuster | hydrogen phosphate | | | |
| mix | and trisodium | | | |
| | citrate | | | |
| Emulsifier | Mixture of acid casein, | 5.4 | 5.4 | 5.4 |
| mix | sodium hydroxide, | | | |
| | sorbitan fatty acid ester, | | | |
| | and glycerin fatty acid ester | | | |
| Total | | 115.8 | 115.8 | 115.8 |

units: parts by mass

2. Preparation of Curry (Reference Example 3, Example 13, Comparative Example 4)

Following the quantities in table 18 below, water was introduced into a stainless-steel flat-bottomed pot and heated using an induction heater (KZ-PH1; Matsushita Electric Industrial), and the water was boiled. Heating was stopped, the lid was opened, curry roux was shaken into the boiling water in successive, small amounts, and the mixture was stirred with a wooden spatula. After the curry roux was mixed in, the pot was placed on the induction heater and the mixture was stirred for ten minutes while being heated at heating level 3. After the pulverized oils/fats had also been added and mixed in, heating was stopped, whereby curries were prepared.

TABLE 18

| | Ref. | | Comp. |
|---|---|---|---|
| | Example 3 | Example | Example |
| Material | (Control) | 13 | 4 |
| Curry roux (Prime Vermont Curry | 6.1 | 6.1 | 6.1 |
| med-spicy, oil/fat content: 24.5 | | | |
| mass %; House Foods Corp.) | | | |
| Water | 92.9 | 92.9 | 92.9 |
| Pulverulent oil/fat (Prepar. | 1.0 | | |
| Example 13) | | | |
| Pulverulent oil/fat (Prepar. | | 1.0 | |
| Example 14) | | | |
| Pulverulent oil/fat (Prepar. | | | 1.0 |
| Example 15) | | | |
| Total | 100.0 | 100.0 | 100.0 |
| Oil content | 1.9 | 1.9 | 1.9 |
| Oxidized oil/fat content | — | 100 ppm | 100 ppm |
| | | by mass | by mass |

units: % by mass except where otherwise noted

3. Evaluation of Oiliness/Fattiness

For curry blended with pulverulent oil/fat containing an oxidized oil/fat of which the oil/fat starting material was rapeseed oil or anhydrous milk fat, oiliness/fattiness was evaluated by making comparisons with Reference Example 3 prepared as described above. The results are shown in table 19. The evaluation was made by three panelists through consensus.

With a curry blended with pulverulent oil/fat containing an oxidized oil/fat of which the oil/fat starting material was anhydrous milk fat (Example 13), oiliness/fattiness higher than that of the curry in Reference Example 3 was obtained, and the results indicated that oiliness/fattiness was enhanced. With a curry blended with pulverulent oil/fat containing an oxidized oil/fat of which the oil/fat starting material was rapeseed oil (Comparative Example 4), oiliness/fattiness was the same as that of the curry in Reference Example 3, and the results indicated that there was no effect of enhancing oiliness/fattiness.

TABLE 19

| Example 13 | Comparative Example 4 |
|---|---|
| Oiliness/fattiness enhanced | Oiliness/fattiness no different |
| more than Ref. Example 3 | from Ref. Example 3 |

<7. Examination of Oxidized Oil/Fat Containing Milk Fat and Edible Oil/Fat Other than Milk Fat>

1. Oxidized Oil/Fat Containing Milk Fat and Edible Oil/Fat other than Milk Fat (Preparation Example 16)

60 g of a medium-chain fatty acid triglyceride (Actor M-107FR, made by RIKEN Vitamin Co., Ltd.) was mixed into 140 g of anhydrous milk fat, and an oil/fat containing 70% by mass of milk fat was prepared. 200 g of the prepared oil/fat was put into a stainless-steel beaker and stirred while being heated to 120° C., and air (200 mL/min) was supplied. The air supply time was 13 hours, and after the mixture cooled, an oxidized oil/fat was obtained. The peroxide value (POV) of the obtained oxidized oil/fat was found to be 59 upon being measured according to “Standard methods for the analysis of fats, oils and related materials, 2.5.2 Peroxide values”.

2. Oxidized Oil/Fat Containing Milk Fat and Edible Oil/Fat other than Milk Fat (Preparation Example 17)

Other than soybean oil (J-Oil Mills) being used instead of the medium-chain fatty acid triglyceride in Preparation Example 16, the process was the same; an oxidized oil/fat was obtained, and the peroxide value was measured and found to be 45.

3. Oxidized Oil/Fat Containing Milk Fat and Edible Oil/Fat other than Milk Fat (Preparation Example 18)

50 parts by mass of high-oleic-acid, low-linolenic-acid rapeseed oil (J-Oil Mills) was mixed into 50 parts by mass of anhydrous milk fat, and an oil/fat containing 50% by mass of milk fat was prepared. 200 g of the prepared oil/fat was introduced into a stainless-steel beaker and stirred while being heated at 100° C., and air (200 mL/min) was supplied. The air supply time was 36 hours, and after the mixture cooled, an oxidized oil/fat was obtained, and the peroxide value was measured and found to be 100.

4. Oxidized Oil/Fat Containing Milk Fat and Edible Oil/Fat other than Milk Fat (Preparation Example 19)

80 parts by mass of high-oleic-acid, low-linolenic-acid rapeseed oil was mixed into 20 parts by mass of anhydrous milk fat, and oil/fat containing 20% by mass of milk fat was prepared. 200 g of the prepared oil/fat was introduced into a stainless-steel beaker and stirred while being heated to 100° C., and air (200 mL/min) was supplied. The air supply time was 30 hours, and after the mixture cooled, an oxidized oil/fat was obtained, and the peroxide value was measured and found to be 105.

<8. Examination of Oxidized Oils/Fats having Different Air Supply Amounts>

1. Oxidized Oil/Fat of Anhydrous Milk Fat (Preparation Example 20)

200 g of anhydrous milk fat was introduced into a stainless-steel beaker and stirred while being heated at 100° C., and air (5 mL/min) was supplied. The air supply time was 33 hours, and after the mixture cooled, an oxidized oil/fat was obtained, and the peroxide value was measured and found to be 47.

1. An oiliness/fattiness enhancer for foods characterized by containing, as an active ingredient, an oxidized oil/fat having a peroxide value of 20 or more to 400 or less and containing milk fat in an amount of 10% by mass or more to 100% by mass or less.

2. The oiliness/fattiness enhancer for foods according to claim 1, containing the oxidized oil/fat in an amount of 0.001% by mass or more to 100% by mass or less.

3. The oiliness/fattiness enhancer for foods according to claim 1, wherein the milk fat is anhydrous milk fat.

4. The oiliness/fattiness enhancer for foods according to claim 1, including a pulverulent oil/fat containing the oxidized oil/fat and an excipient.

5. The oiliness/fattiness enhancer for foods according to claim 1, for being applied to a food having an oil/fat content of 0.1% by mass or more to 70% by mass or less.

6. The oiliness/fattiness enhancer for foods according to claim 5, wherein the food is any one food selected from the group consisting of a dressing, a roux, and a soup.

7. A food containing the oiliness/fattiness enhancer for foods according to claim 1.

8. The food according to claim 7, containing the oxidized oil/fat in the oiliness/fattiness enhancer for foods in an amount of 0.01 ppm by mass or more to 500 ppm by mass or less.

9. The food according to claim 7, wherein the oil/fat content of the food is 0.1% by mass or more to 70% by mass or less.

10. The food according to claim 7, wherein the food is any one food selected from the group consisting of a dressing, a roux, and a soup.

11. The food according to claim 7, wherein the food is any one food selected from the group consisting of a dressing having an oil/fat content of 1% by mass or more to 40% by mass or less, a roux having an oil/fat content of 5% by mass or more to 30% by mass or more, and a soup having an oil/fat content of 0.1% by mass or more to 5% by mass or less.
